(19) United States
(12) Patent Application Publication
(10) Pub. No.: US 2015/0341659 A1
(43) Pub. Date: Nov. 26, 2015

(54) USE OF PIPELINED HIERARCHICAL MOTION ESTIMATOR IN VIDEO CODING

(71) Applicant: Apple Inc., Cupertino, CA (US)

(72) Inventors: Jian Lou, Cupertino, CA (US); Xiaojin Shi, Fremont, CA (US); Jian Zhou, Fremont, CA (US)

(21) Appl. No.: 14/696,162

(22) Filed: Apr. 24, 2015

Related U.S. Application Data
(60) Provisional application No. 62/001,998, filed on May 22, 2014.

(51) Int. Cl. H04N 19/577

(52) U.S. Cl. CPC H04N 19/577

(57) ABSTRACT

A pipelined video coding system may include a motion estimation stage and an encoding stage. The motion estimation stage may operate on an input frame of video data in a first stage of operation and may generate estimates of motion and other statistical analyses. The encoding stage may operate on the input frame of video data in a second stage of operation later than the first stage. The encoding stage may perform predictive coding using coding parameters that are selected, at least in part, from the estimated motion and statistical analysis generated by the motion estimator. Because the motion estimation is performed at a processing stage that precedes the encoding, a greater amount of processing time may be devoted to such processes than in systems that performed both operations in a single processing stage.

### BACKGROUND

This application benefits from priority of application Ser. No. 62/001,998, filed on May 22, 2014, the disclosure of which is incorporated herein in its entirety.

Many video compression standards, e.g. H.264/AVC and H.265/HEVC, have been widely used in video capture, video storage, real time video communication and video transcoding. Examples of popular applications include Apple's AirPlay Mirroring, FaceTime and iPhone/iPad video capture.

Most video compression standards achieve much of their compression efficiency by searching for a reference picture by motion compensation, using it as a prediction for the current picture, and coding only the difference between the current picture and the prediction. The highest rates of compression can be achieved when the prediction is highly correlated to the current picture. One of the major challenges that such systems face is how to achieve good compressed video visual quality during illumination changes, such as fading transitions. The current picture is more strongly correlated to the reference picture scaled by a weighting factor with an offset than to the reference picture itself. In order to solve this problem, the weighted prediction (WP) tool has been adopted in the H.264/AVC and H.265/HEVC video coding standards to improve coding efficiency by applying a multiplicative weighting factor and an additive offset to the motion compensated prediction to form a weighted prediction. Even though weighted prediction was originally designed to handle fading and cross-fading, better compression efficiency could also be obtained, as weighted prediction cannot only manage local illumination variations, but also improve sub-pixel precision for motion compensation using reference picture lists with duplicate references.

Optimal solutions are obtained when illumination compensation weights, motion estimation and rate distortion optimization are optimized jointly. However, they are generally based on iterative methods requiring large computation times, which are not acceptable for many applications (e.g., real time coding). Moreover, convergence may not be guaranteed.

Many algorithms rely on a relatively long window of pictures to observe enough statistics for an accurate detection. However, such methods require the availability of the statistics of the entire fade duration, which introduces long delays and is impractical in real-time encoding systems, particularly those that select coding parameters in a pipelined fashion (e.g., on a pixel-block-by-pixel-block basis) where such statistics are unavailable.

Most of the weighted prediction parameters estimation algorithms can be described as a three step process. In the first step, a picture signal analysis is performed to extract image characteristics. It could be applied to the current (original) picture and the reference (original or reconstructed) picture. Various statistics could be extracted, such as the mean of the whole picture pixel values, the standard deviation of the whole picture pixel values, the mean square of the whole picture pixel values, the mean of the product of the co-located pixel values, the mean of the pixel gradients, the pixel histogram, etc. The next stage is the weighted prediction parameter value estimation. Finally, it is decided whether weighted prediction is applied or not to compress the current picture.

In many practical encoder designs, especially for real time applications, the encoders are not able to analyze the current picture to get the statistics needed for estimating the optimal weighted prediction parameter(s) before the encoding process starts. This constraint prevents the weighted prediction to be applied for this kind of encoder.

### BRIEF DESCRIPTION OF THE DRAWINGS

FIG. 1 is a simplified block diagram of a video coding system according to an embodiment of the present disclosure.

FIG. 2 is a functional block diagram of a video coding system according to an embodiment of the present disclosure.

FIG. 3 illustrates a video coder according to an embodiment of the present disclosure.

FIG. 4 illustrates a hierarchical motion estimator according to an embodiment of the present disclosure.

### DETAILED DESCRIPTION

Embodiments of the present disclosure provide a pipelined video coding system that includes a motion estimation stage and an encoding stage. The motion estimation stage may operate on an input frame of video data in a first stage of operation and may generate estimates of motion and other statistical analyses. The encoding stage may operate on the input frame of video data in a second stage of operation later than the first stage. The encoding stage may perform predictive coding using coding parameters that are selected, at least in part, from the estimated motion and statistical analysis generated by the motion estimator. Because the motion estimation is performed at a processing stage that precedes the encoding, a greater amount of processing time may be devoted to such processes than in systems that performed both operations in a single processing stage.

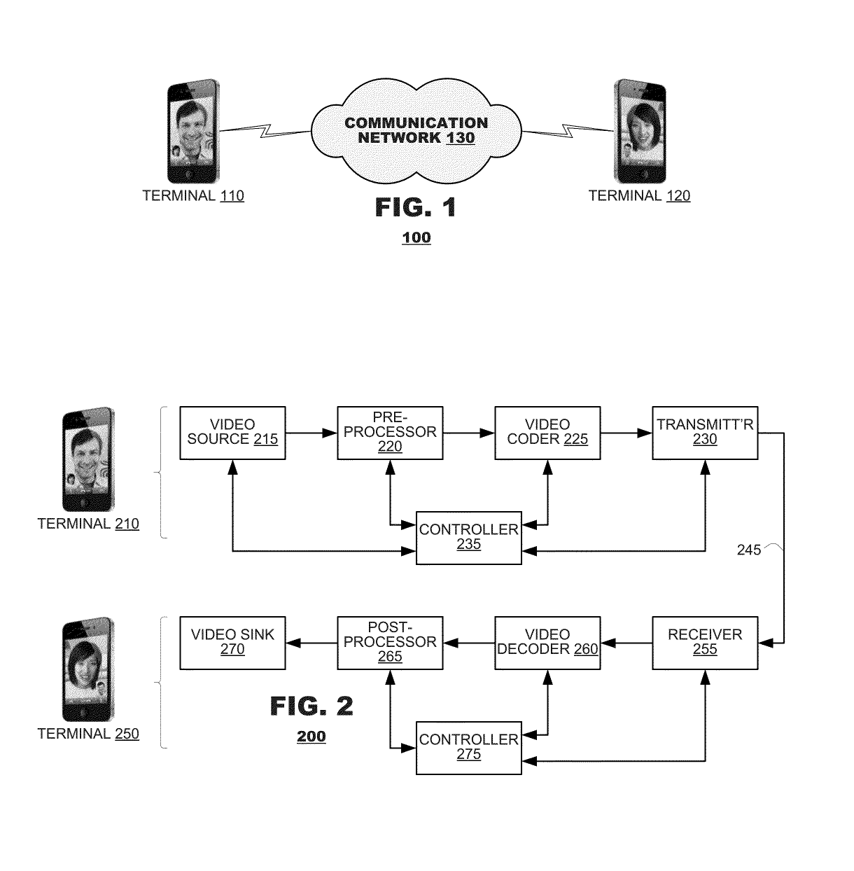

FIG. 1 illustrates a simplified block diagram of a video coding system 100 according to an embodiment of the present disclosure. The system 100 may include at least two terminals 110-120 interconnected via a network 130. For unidirectional transmission of data, a first terminal 110 may code video data at a local location for transmission to the other terminal 120 via the network 130. The second terminal 120 may receive the coded video data of the other terminal from the network 130, decode the coded data and display the recovered video data. Unidirectional data transmission is common in media-serving applications and the like.

For bidirectional transmission of data, however, each terminal 110, 120 may code video data captured at a local location for transmission to the other terminal via the network 130. Each terminal 110, 120 also may receive the coded video data transmitted by the other terminal, may decode the coded data and may display the recovered video data at a local display device. Bidirectional data transmission is common in communication applications such as video calling or video conferencing.

In FIG. 1, the terminals 110-120 are illustrated as smart phones but the principles of the present disclosure are not so limited. Embodiments of the present disclosure find application with laptop computers, tablet computers, servers, media players and/or dedicated video conferencing equipment. The network 130 represents any number of networks that convey coded video data among the terminals 110-120, including, for example, wireline and/or wireless communication networks. The communication network 130 may exchange data in circuit-switched and/or packet-switched channels. Representative networks include telecommunications networks, local area networks, wide area networks and/or the Internet. For the purposes of the present discussion, the architecture and topology of the network 130 is immaterial to the operation of the present disclosure unless explained hereinbelow.

FIG. 2 is a functional block diagram of a video coding system 200 according to an embodiment of the present disclosure. In this example, only the components that are relevant to a unidirectional coding session are illustrated.

A first terminal 210 may include a video source 215, a pre-processor 220, a video coder 225, a transmitter 230, and a controller 235. The video source 215 may provide video to be coded by the terminal 210. The pre-processor 220 may perform various analytical and signal conditioning operations on the video data, often to condition it for coding. The video coder 225 may apply coding operations to the video sequence to reduce the video sequence's bit rate. The transmitter 230 may buffer coded video data, format it for transmission to a second terminal 250 and transmit the data to a channel 245. The controller 235 may manage operations of the first terminal 210.

Embodiments of the present disclosure find application with a variety of video sources 215. In a videoconferencing system, the video source 215 may be a camera that captures local image information as a video sequence. In a gaming or graphics-authoring application, the video source 215 may be a locally-executing application that generates video for transmission. In a media serving system, the video source 215 may be a storage device storing previously prepared video.

Embodiments of the present disclosure also find application with a variety of pre-processors 220. For example, the pre-processor 220 may search for video content in the source video sequence that is likely to generate artifacts when the video sequence is coded, decoded and displayed. The pre-processor 220 also may apply various filtering operations to the frame data to improve efficiency of coding operations applied by a video coder 225.

As noted, the video coder 225 may perform coding operations on the video sequence to reduce the sequence's bit rate. The video coder 225 may code the input video data by exploiting temporal and spatial redundancies in the video data. For example, the video coder 225 may apply coding operations that are mandated by a governing coding protocol, such as the ITU-T H.264/AVC and H.265/HEVC coding standards.

The transmitter 230 may transmit coded data to the channel 245. In this regard, the transmitter 230 may merge coded video data with other data streams, such as audio data and/or application metadata, into a unitary data stream (called “channel data” herein). The transmitter 230 may format the channel data according to requirements of the channel 245 and transmit it to the channel 245.

The first terminal 210 may operate according to a coding policy, which is implemented by the controller 235 and video coder 225 that select coding parameters to be applied by the video coder 225 in response to various operational constraints. Such constraints may be established by, among other things: a data rate that is available within the channel to carry coded video between terminals, a size and frame rate of the source video, a size and display resolution of a display at a terminal 250 that will decode the video, and error resiliency requirements required by a protocol by which the terminals operate. Based upon such constraints, the controller 235 and/or video coder 225 may select a target bit rate for coded video (for example, as N bits/sec) and an acceptable coding error for the video sequence. Thereafter, they may make various coding decisions to individual frames of the video sequence. For example, the controller 235 and/or video coder 225 may select a frame type for each frame, a coding mode to be applied to pixel blocks within each frame, and quantization parameters to be applied to frames and or pixel blocks.

During coding, the controller 235 and/or video coder 225 may assign to each frame a certain frame type, which can affect the coding techniques that are applied to the respective frame. For example, frames often are assigned as one of the following frame types:
An Intra Frame (I frame) is one that is coded and decoded without using any other frame in the sequence as a source of prediction,
A Predictive Frame (P frame) is one that is coded and decoded using earlier frames in the sequence as a source of prediction,
A Bidirectionally Predictive Frame (B frame) is one that is coded and decoded using both earlier and future frames in the sequence as sources of prediction.

A video coder 225 commonly parses input frames into a plurality of pixel blocks (for example, blocks of 4×4, 8×8 or 16×16 pixels each) and coded on a pixel-block-by-pixel-block basis. Pixel blocks may be coded predictively with reference to other coded pixel blocks as determined by the coding assignment applied to the pixel blocks' respective frame. For example, pixel blocks of I frames can be coded non-predictively or they may be coded predictively with reference to pixel blocks of the same frame (spatial prediction). Pixel blocks of P frames may be coded non-predictively, via spatial prediction or via temporal prediction with reference to one previously coded reference frame. Pixel blocks of B frames may be coded non-predictively, via spatial prediction or via temporal prediction with reference to one or two previously coded reference frames.

FIG. 2 also illustrates components of a second terminal 250 that may receive and decode the coded video data. The second terminal 250 may include a receiver 255, a video decoder 260, a post-processor 265, a video sink 270, and a controller 275.

The receiver 255 may receive channel data from the channel 245 and parse it according to its constituent elements. For example, the receiver 255 may distinguish coded video data from coded audio data and route each coded data to decoders to handle them. In the case of coded video data, the receiver 255 may route it to the video decoder 260.

The video decoder 260 may perform decoding operations that invert processes applied by the video coder 225 of the first terminal 210. Thus, the video decoder 260 may perform prediction operations according to the coding mode that was identified and perform entropy decoding, inverse quantization and inverse transforms to generate recovered video data representing each coded frame.

The post-processor 265 may perform additional processing operations on recovered video data to improve quality of the video prior to rendering. Filtering operations may include, for example, filtering at pixel block edges, anti-banding filtering and the like.

The video sink 270 may consume the reconstructed video. The video sink 270 may be a display device that displays the reconstructed video to an operator. Alternatively, the video sink may be an application executing on the second terminal 250 that consumes the video (as in a gaming application).

FIG. 2 illustrates only the components that are relevant to unidirectional exchange of coded video. As discussed, the principles of the present disclosure also may apply to bidirectional exchange of video. In such an embodiment, the elements 215-235 illustrated for capture and coding of video at the first terminal 210 may be replicated at the second terminal 250. Similarly the elements 255-275 illustrated for decoding and rendering of video at the second terminal 250 may be replicated at the first terminal 210. Indeed, it is permissible for terminals 210, 250 to have multiple instantiations of these elements to support exchange of coded video with multiple terminals simultaneously, if desired.

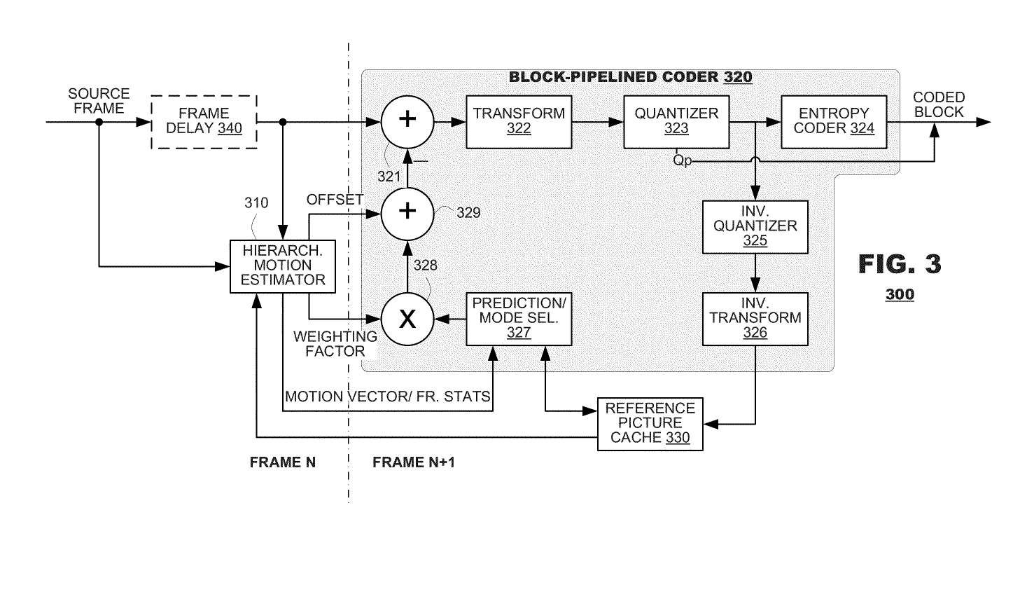

FIG. 3 illustrates a video coder 300 according to an embodiment of the present disclosure. The video coder 300 may include a hierarchical motion estimator (HME) 310, a block-pipelined coder (BPC) 320, and a reference picture cache 330. The video coder 300 may operate in a pipelined fashion where the HME 310 operates on data from one frame (labeled “frame N” herein) while the BPC 320 operates on data from a prior frame (“frame N+1”) (via delay element 340). A given frame will be processed by the HME 310 and statistics for the coding operations will have been developed before the frame is input to the BPC 320 for coding. The principles of the present disclosure alleviate constraints encountered by other kind of encoders, which may attempt to develop statistics on an input frame as that frame is being coded and do not have processing resources to analyze the frames effectively.

The HME 310 may estimate motion of image content from the content of a frame. Typically, the HME 310 may analyze frame content at two or more levels of data to estimate motion. The HME 310, therefore, may output a motion vector representing identified motion characteristics that are observed in motion content. The motion vector may be output to the BPC 320 to aid in prediction operations.

The HME 310 also may perform statistical analyses of the frame N and output data representing those statistics. The statistics also may be output to the BPC 320 to assist in mode selection operations, discussed below.

The HME 310 further may determine weighting factors and offset values to be used in weighted prediction. The weighting factors and offset values also may be output to the BPC 320.

The BPC 320 may include a subtractor 321, a transform unit 322, a quantizer 323, an entropy coder 324, an inverse quantizer 325, an inverse transform unit 326, a prediction/mode selection unit 327, a multiplier 328, and an adder 329.

The BPC 320 may operate on an input frame N+1 on a pixel-block-by-pixel-block basis. Typically, a frame N+1 of content may be parsed into a plurality of pixel blocks, each of which may correspond to a respective spatial area of the frame. The BPC 320 may process each pixel block individually.

The subtractor 321 may perform a pixel-by-pixel subtraction between pixel values in the source frame N+1 and any pixel values that are provided to the subtractor 321 by the prediction/mode selection unit 327. The subtractor 321 may output residual values representing results of the subtraction on a pixel-by-pixel basis. In some cases, the prediction/mode selection unit 327 may provide no data to the subtractor 321 in which case the subtractor 321 may output the source pixel values without alteration.

The transform unit 322 may apply a transform to a pixel block of input data, which converts the pixel block to an array of transform coefficients. Exemplary transforms may include discrete cosine transforms and wavelet transforms. The transform unit 322 may output transform coefficients for each pixel block to the quantizer 323.

The quantizer 323 may apply a quantization parameter Qp to the transform coefficients output by the transform unit 322. The quantization parameter Qp may be a single value applied uniformly to each transform value in a pixel block or, alternatively, it may represent an array of values, each value being applied to a respective transform coefficient in the pixel block. The quantizer 323 may output quantized transform coefficients to the entropy coder 324.

The entropy coder 324, as its name applies, may perform entropy coding of the quantized transform coefficients presented to it. The entropy coder 324 may output a serial data stream, typically run-length coded data, representing the quantized transform coefficients. Typical entropy coding schemes include variable length coding and arithmetic coding. The entropy coded data may be output from the BPC 320 as coded data of the pixel block. Thereafter, it may be merged with other data such as coded data from other pixel blocks and coded audio data and be output to a channel (not shown).

The BPC 320 may include a local decoder formed of the inverse quantizer unit 325, inverse transform unit 326, and an adder (not shown) that reconstruct select coded frames, called “reference frames.” Reference frames are frames that are selected as a candidate for prediction of other frames in the video sequence. When frames are selected to serve as reference frames, a decoder (not shown) must decoded the coded reference frame and store it in a local cache for later use. The encoder also includes decoder components so it may decode the coded reference frame data and store it in its own cache. Thus, absent transmission errors, the encoder's reference picture cache 330 and the decoder's reference picture cache (not shown) should store the same data.

The inverse quantizer unit 325 may perform processing operations that invert coding operations performed by the quantizer 323. Thus, the transform coefficients that were divided down by a respective quantization parameter may be scaled by the same quantization parameter. Quantization often is a lossy process, however, and therefore the scaled coefficient values that are output by the inverse quantizer unit 325 oftentimes will not be identical to the coefficient values that were input to the quantizer 323.

The inverse transform unit 326 may invert transformation processes that were applied by the transform unit 322. Again, the inverse transform unit 326 may apply discrete cosine transforms or wavelet transforms to match those applied by the transform unit 322. The inverse transform unit may generate pixel values, which approximate prediction residuals input to the transform unit 322.

Although not shown in FIG. 3, the BPC 320 may include an adder to add predicted pixel data to the decoded residuals output by the inverse transform unit 326 on a pixel-by-pixel basis. The adder may output reconstructed image data of the pixel block. The reconstructed pixel block may be assembled with reconstructed pixel blocks for other areas of the frame and stored in the reference picture cache 330.

The prediction unit 327 may perform mode selection and prediction operations for the input pixel block. In doing so, the prediction unit 327 may select a type of coding to be applied to the pixel block, for example intra-prediction, unidirectional inter-prediction or bidirectional inter-prediction. For either type of inter prediction, the prediction unit 327 may perform a prediction search to identify, from a reference picture stored in the reference picture cache 330, stored data to serve as a prediction reference for the input pixel block. The prediction unit 327 may generate identifiers of the prediction reference by providing motion vectors or other metadata (not shown) for the prediction. The motion vector may be output from the BPC 320 along with other data representing the coded block.

The multiplier 328 and adder 329 may apply a weighting factor and offset to the predicted data generated by the prediction unit 327. Specifically, the multiplier 328 may scale the predicted data according to the weighting factor provided by the HME 310. The adder 329 may add an offset value to the output of the multiplier, again, using a value that is provided by the HME. Data output from the adder 329 may be input to the subtractor 321 as prediction data.

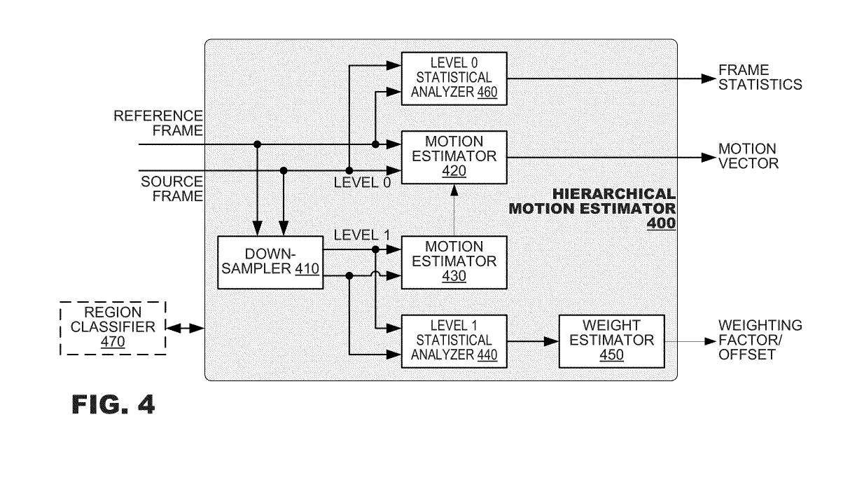

The principles of the present disclosure conserve resources expended in a video coder by staggering operation of the HME 310 and the BPC 320. In many coding implementations, especially for real time applications, a video coder cannot review all pixel values for a frame being coded (frame N+1) to develop statistics needed for estimating an optimal set of weighted prediction parameter(s) before the encoding process starts. Embodiments of the present disclosure overcome such limitations by performing such analyses in an HME 310 which operates a frame ahead of coding operations. A given frame will be processed by the HME 400 (FIG. 4), and statistics for the coding operations will have been developed before the frame is input to the video coder 320 for coding. Thus, the principles of the present disclosure alleviate constraints encountered by other kinds of encoders.

In practice, it may be convenient to provide the HME 310 and BPC 320 as separate circuit systems of a common integrated circuit.

FIG. 4 illustrates a hierarchical motion estimator 400 according to an embodiment of the present disclosure. The HME may include a downsampler 410, a pair of motion estimators 420, 430 each associated with a respective level of sampling, a pair of statistical analyzers 440, 460 again each associated with a respective level of sampling, and a weight estimator 450. The HME 400 may receive input data of a source frame and of a selected reference frame and output data representing a frame motion vector, frame statistics and weighting factor/offset data.

The downsampler 410 may perform a downsampling of the input frames, both the source frame and the reference frame. Typical downsampling operations include a 2×2 or 4×4 downsampling of the input frames. Thus, the downsampler 410 may output a representation of video data that has a lower spatial resolution than the input frames. For convenience, the downsampled frame data is labeled “level 1” and the original resolution frame data is labeled “level 0.”

The motion estimators 420, 430 each may perform motion analysis on the source frame using the reference frame data as a reference point. The level 1 motion estimator 430 is expected to perform its analysis more quickly than the level 0 motion estimator 420 because the level 1 motion estimator 430 is operating on a lower resolution of the frame data than the level 0 estimator 420 does.

The level 1 statistical analyzer 440 may perform statistical analyses on the level 1 source frame. The level statistical 1 analyzer may collect data on any or all of the following metrics:
the mean of the whole picture pixel values,
the standard deviation of the whole picture pixel values,
the mean square of the whole picture pixel values,
the mean of the product of the co-located pixel values,
the mean of the pixel gradients,
the pixel histogram,
the sum of absolute differences (SAD) between pixel values of the downsampled source frame data and reference frame data,
the sum of absolute transform difference (SATD) between pixel values of the downsampled source frame data and reference frame data, and/or
mean square error (MSE) between pixel values of the downsampled source frame data and reference frame data.

The weight estimator 450 may derive weighting factors and offsets for use in weighted prediction. In an embodiment, the weight estimator 450 may derive its weights using results of the level 1 motion estimator 430.

The level 0 statistical analyzer 460 may perform statistical analyses on the level 0 source frame. The level 0 statistical analyzer 460 may collect data on any or all of the metrics listed above for level 1.

Embodiments of the present disclosure also may include a region classifier 470 that works in conjunction with an HME 400. In such an embodiment, an HME 400 may analyze a source frame with regard to several different reference frames. The HME 400 may perform its processes for each of the reference frames and generate sets of weighting parameters, a weighting factor and offset, for each such reference frame. The HME 400 may output all sets of weighting parameters to a BPC (FIG. 3) for use in prediction. Moreover, the HME 400 may generate sets of statistics for each reference picture, which a BPC may use for reference picture reordering. For the encoding process for the current picture after the low resolution motion estimation/HME, more than one set of weight prediction parameters could be used to improve coding efficiency and visual quality.

FIG. 4 illustrates a region classifier 470 for such purposes. The region classifier 470 may control other components of the HME 400 (elements 410-460) to perform their operations iteratively over several different reference frames.

In an embodiment, the region classifier 470 may detect regions within frames that share similar content and may cause the HME 400 to develop sets of weighted prediction parameters independently for each region according to their image content. The region classifier 470 may assign image content to different regions according to:
the mean of the region pixel values,
the standard deviation of the region pixel values,
the mean square of the region pixel values,
the mean of the product of the co-located region pixel values,
the mean of the region pixel gradients,
the region pixel histogram,
the sum of absolute differences (SAD) between pixel values of the downsampled source region data and reference region data,
the sum of absolute transform difference (SATD) between pixel values of the down sampled source region data and reference region data
mean square error (MSE) between pixel values of the downsampled source region data and reference region data, and/or
the sum of absolute motion vectors of the region pixel/block values.

In another embodiment, such regions may be identified based not only on similarities observed between spatially adjacent elements of image content but also based on similarities observed between image content and co-located image content in temporally-adjacent frames. Typically, contiguous areas of frames that exhibit similarities in one or more of the foregoing statistics may be assigned to a common region.

Once regions are identified from within a frame, the HME 400 may operate on the regions separately and develop weighted prediction parameters independently for the regions according to their respective statistics.

The foregoing discussion has described operation of the embodiments of the present disclosure in the context of terminals that embody encoders and/or decoders. Commonly, these components are provided as electronic devices. They can be embodied in integrated circuits, such as application specific integrated circuits, field programmable gate arrays and/or digital signal processors. Alternatively, they can be embodied in computer programs that execute on personal computers, notebook computers, tablet computers, smartphones or computer servers. Such computer programs typically are stored in physical storage media such as electronic-, magnetic- and/or optically-based storage devices, where they are read to a processor under control of an operating system and executed. Similarly, decoders can be embodied in integrated circuits, such as application specific integrated circuits, field-programmable gate arrays and/or digital signal processors, or they can be embodied in computer programs that are stored by and executed on personal computers, notebook computers, tablet computers, smartphones or computer servers. Decoders commonly are packaged in consumer electronics devices, such as gaming systems, DVD players, portable media players and the like; and they also can be packaged in consumer software applications such as video games, browser-based media players and the like. And, of course, these components may be provided as hybrid systems that distribute functionality across dedicated hardware components and programmed general-purpose processors, as desired.

Several embodiments of the disclosure are specifically illustrated and/or described herein. However, it will be appreciated that modifications and variations of the disclosure are covered by the above teachings and within the purview of the appended claims without departing from the spirit and intended scope of the disclosure.

We claim:

1. A pipelined video coding system, comprising:
a motion estimation stage and an encoding stage, the motion estimation stage to operate on an input frame of video data in a first stage of operation and the encoding stage to operate on the input frame of video data in a second stage of operation later than the first stage,
the motion estimation stage comprising a motion estimator to estimate motion between elements of the input frame and elements of a reference frame and a statistics analyzer to perform a statistical analysis of differences between the input frame and the reference frame, and
the encoding stage comprising a predictive coder that selects coding parameters, at least in part, from the estimated motion and statistical analysis generated by the motion estimator.

2. The system of claim 1, wherein the motion estimation stage further comprises:
a downsampler having inputs for the input frame and the reference frame,
a second motion estimator having inputs coupled to the downsampler to estimate motion between a downsampled input frame and a reference frame, and
a second statistics analyzer to perform a statistical analysis of differences between the downsampled input frame and the downsampled reference frame.

3. The system of claim 1, wherein:
the motion estimation stage further comprises a weight estimator to generate a weighting factor and an offset factor for weighted prediction coding, and
the encoding system performs the weighted prediction coding and applies the weighting factor and the offset factor as part of the weighted prediction coding.

4. The system of claim 1, further comprising a reference picture cache to store reference frames, the reference picture cache provided in communication with the motion estimation stage and the encoding stage.

5. The system of claim 1, wherein the motion estimation stage estimates motion between the input frame and each of a plurality of reference frames and outputs data representing each motion estimation to the encoding stage.

6. The system of claim 1, wherein the motion estimation stage and the encoding stage are separate circuit systems of a common integrated circuit.

7. A coding method, comprising:
performing motion estimation and block-based coding of an input video sequence in separate pipelined stages of operation,
a first stage including the motion estimation of elements of input frames of the video sequence with reference to elements of respective reference frames, and
a subsequent second stage including the block-based coding of the input frames using estimated motion developed from the first stage.

8. The method of claim 7, wherein the motion estimation comprises:
downsampling at least one input frame and its respective reference frame, and
comparing content of the downsampled input frame with the downsampled respective reference frame.

9. The method of claim 8, wherein the motion estimation comprises estimating a sum of absolute differences (SAD) between pixel values of the downsampled input frame and the downsampled reference frame.

10. The method of claim 8, wherein the motion estimation comprises estimating a sum of absolute transform differences (SATD) between pixel values of the downsampled input frame and downsampled reference frame.

11. The method of claim 8, wherein the motion estimation comprises estimating a mean square error (MSE) between pixel values of the downsampled input frame and the downsampled reference frame.

12. The method of claim 7, wherein:
the motion estimation comprises estimating a weighting factor and an offset factor for weighted prediction coding, and
the block-based coding applies the weighting factor and the offset factor as part of the weighted prediction coding.

13. The method of claim 7, wherein the motion estimation comprises estimating a mean of pixel values of the input frame and the reference frame.

14. The method of claim 7, wherein the motion estimation comprises estimating a mean square of pixel values of the input frame and the reference frame.

15. The method of claim 7, wherein the motion estimation comprises estimating a mean of a product of co-located pixel values in the input frame and the reference frame.

16. The method of claim 7, wherein the motion estimation comprises estimating a mean of pixel gradients between the input frame and the reference frame.

17. The method of claim 7, wherein the motion estimation comprises estimating pixel histogram of a downsampled input frame.

18. A computer readable storage device having program instructions stored thereon that, when executed by a processing device, causes the device to:
perform motion estimation and block-based coding of an input video sequence in separate pipelined stages of operation,
a first stage including the motion estimation of elements of input frames of the video sequence with reference to elements of respective reference frames, and
a second, subsequent stage including block-based coding of the input frames using estimated motion developed from the first stage.

19. The storage device of claim 18, wherein the motion estimation comprises:
downsampling at least one input frame and its respective reference frame, and
comparing content of the downsampled input frame with the downsampled respective reference frame.

20. The storage device of claim 18, wherein:
the motion estimation comprises estimating a weighting factor and an offset factor for weighted prediction coding, and
the block-based coding applies the weighting factor and the offset factor as part of the weighted prediction coding.

21. The storage device of claim 18, wherein the storage device further comprises a reference picture cache to store reference picture data, the reference picture cache provided in communication with the motion estimation stage and the encoding stage.

22. The storage device of claim 18, wherein the motion estimation stage estimates motion between the input frame and each of a plurality of reference frames and outputs data representing each motion estimation to the encoding stage.
